(19) United States
(12) Patent Application Publication
(10) Pub. No.: US 2024/0151739 A1
(43) Pub. Date: May 9, 2024

(54) TRANSPORT SYSTEM FOR TRANSPORTING SPECIMENS IN A MEDICAL ANALYSIS LABORATORY

(71) Applicant: ConScience analytics GmbH, Hamburg (DE)

(72) Inventor: André VON FROREICH, Hörnum/Sylt (DE)

(73) Assignee: ConScience analytics GmbH, Hamburg (DE)

(21) Appl. No.: 18/495,841

(22) Filed: Oct. 27, 2023

(30) Foreign Application Priority Data
Nov. 3, 2022 (EP) 22205303.5

(51) Int. Cl. G01N 35/04; G01N 35/00; G05D 1/02

(52) U.S. Cl. CPC G01N 35/04; G01N 35/00732; G05D 1/0223; G01N 2035/0477; G01N 2035/0489

(57) ABSTRACT

A transport system for transport of specimens in a medical or chemical analysis laboratory. The system includes a transport track predefining travel paths, and at least one self-propelled transport carriage configured to moving along the travel paths. The carriage has a specimen receptacle, four wheels driven by an electric motor, an electrical energy store for providing power to a motor drive, and a motor drive controller. The carriage wheels are arranged on two axes aligned parallel to one another, with only the wheels of a first axle being driven. Each wheel of the driven axle is connected to a dedicated electric motor drive and is driven at a rotational speed individually predefined by the controller. Longitudinal grooves are routed along the travel paths in the transport track and a guide projection protruding from the underside of the carriage engages in the longitudinal grooves.

### TECHNICAL FIELD

The present invention relates to a transport system for the transport of specimens in an analysis laboratory—in particular, a medical and/or chemical analysis laboratory, and in particular a system having the features of a transport track which predefines travel paths, and at least one self-propelled transport carriage which is configured for moving along the travel paths on the transport track. The carriage has a receptacle for a specimen to be transported. The transport carriage has wheels driven by an electric motor, an electrical energy store for providing electrical power for the electric motor drive of the wheels, and a controller for the electromotive drive.

### BACKGROUND ART

In medicine, what is known as laboratory medicine is a field with substantial relevance for diagnostics. In this field, specialized and high-quality medical analysis laboratories are working in which medical specimens submitted from various medical facilities, such as medical offices or hospitals, are examined, and analyzed according to a submitted order. Such specimens can in particular be those of body fluids such as, for example, blood specimens or urine specimens, but also stool samples or swabs or the like. The work in such analysis laboratories in particular does not just include medical or clinical chemical tests or analyses, but also such analyses of chemical nature, so that in such analysis laboratories, not only medical, but also chemical specimens can usually be examined.

The specimens are typically submitted by the submitters in specimen vessels provided for this purpose in the medical or chemical analysis laboratory. These are predominantly tube-shaped vessels—usually made of transparent plastic—which are closed for shipping and handling by a cap—usually a screw cap or stopper. Corresponding specimen vessels are often already predetermined by the providers—in particular, by selection of color-coded caps—for receiving specific specimens or specimens for carrying out specific analysis.

The specimen vessels submitted are provided by the submitters with correspondingly coded data sets from which conclusions can be drawn about the origin of the specimen, i.e., the submitter and the patient from which the specimen originates, as well as conclusions about the analysis order associated with the specimen submission. These codings are generally applied by barcodes or QR codes on the specimen vessels and can correlate, for example, with a written order or an electronically-transmitted order in which the corresponding data are reproduced.

In the medical analysis laboratories, a plurality of analysis devices and devices are typically present, with which the specimens can be subjected to certain analyses relevant to medical diagnostics—for example, clinical chemical examinations, morphological blood tests, hormone tests, immunological examinations, marker tests for certain tumor markers, and the like. In addition, preparation devices or devices for so-called pre-analysis are present in the medical analysis laboratories—for example, automatic centrifuges with which incoming specimens can be prepared for subsequent specimen analysis according to the ordered analysis.

In modern medical and/or chemical analysis laboratories, medical and/or chemical specimen analyses are carried out at a high throughput rate and high degree of automation. Incoming specimens are transferred into an automated analysis system, and in particular introduced into a transport system, with which the specimens are then supplied automatically to predetermined destinations and intermediate destinations, e.g., first, a first analysis device for a first medical analysis, then a second analysis device for a second medical analysis, finally an archive, or first a treatment device, such as a centrifuge, then an analysis device, and finally an archive, or are transported further between the individual stations. Because only comparatively low remuneration is paid by the health system in the field of laboratory medicine—in particular, for standardized analyses—a high degree of automation and a high throughput rate are sought for economical operation of an analysis laboratory. Special attention is paid here to the specimen transport within the laboratory apparatus, because the processing speed in this part, i.e., the laboratory logistics, regularly represents a factor limiting the throughput.

Accordingly, nowadays, transport systems are already established in the large medical analysis laboratories in which the specimens, and more precisely the specimen vessels filled with the corresponding specimens, are transported with individual transport carriages along predetermined transport sections and are transported to the respective destinations, whether preparation devices or analysis devices. An example of such a transport system with corresponding transport carriages is disclosed in US 2010/0239461 A1. A further example is described in EP 2 629 100 A1. EP 2 629 099 A1 also deals with automated specimen transport in medical analysis laboratories.

### SUMMARY OF THE INVENTION

A problem with the known transport systems, as they are used for transporting specimens in medical analysis laboratories, is that they are limited on the one hand in the transport speed and thus throughput rate of the laboratory, and that, on the other, the proposed systems are of complicated design and are prone to fail or require maintenance. The present invention here addresses the objective of specifying a transport system that is improved in this respect for transporting specimens in a medical analysis laboratory, which system is robust and as low-maintenance as possible and which enables a high throughput of specimens in the medical analysis laboratory, due to high cycle rate and high transport speed.

This object is achieved by a transport system as described below for transporting specimens in an analysis laboratory—in particular, a medical and/or chemical analysis laboratory.

Accordingly, a transport system for transporting specimens in an analysis laboratory—in particular, a medical and/or chemical analysis laboratory—first has a transport track which predefines travel paths. Furthermore, at least one self-propelled transport carriage configured for moving along the travel paths on the transport track is provided—in particular, several such transport carriages, and preferably a great number of such transport carriages, can be part of the transport system according to the invention. The at least one transport carriage has a receptacle for a specimen to be transported, and typically a receptacle in which a specimen vessel containing the specimen can be received, held, and entrained. The transport carriage of the transport system according to the invention has wheels driven by an electric motor, an electrical energy store for providing electrical energy for the electric motor drive of the wheels, and furthermore a controller for the electric motor drive. With the controller, the electric motor drive can be regulated or adjusted in particular with regard to a drive speed of the wheels. The controller can furthermore be configured in particular to exchange data and signals with an external environment.

The special feature of the transport system according to the invention in a variant according to the invention and essential to the invention is that the transport carriage has four wheels which are each placed in an arrangement of two axes aligned parallel to one another. In other words, two wheels are initially arranged on the transport carriage along a first axis, and two further wheels, in turn, at an offset distance along a second axis. When the arrangement of wheels along an axis is referred to here, this does not mean that the wheels are applied on an actual common axis, but, rather, that the wheels can also mounted individually, and in particular, as explained below. Furthermore, it is important for this design essential to the invention that the wheels of the first axle are driven, whereas the wheels of the second axle are not driven, and that the wheels of the driven axle are in each case connected to a dedicated electric motor drive and can each be driven thereby at a rotational speed that is individually specifiable by the controller. Finally, for this embodiment of the transport system according to the invention, it is important that longitudinal grooves are routed along the travel paths in the transport track and that a guide projection which protrudes on the underside and is designed for engagement in the longitudinal grooves is formed on the at least one transport carriage. In particular, a single longitudinal groove can advantageously be provided for each travel path.

This embodiment according to the invention of the transport system presented here allows a particular advantage in the construction of the transport track. This is because—in particular, where there are branches or convergences of travel paths in the transport track, e.g., in order to move a specimen from a main path routed in a circle towards an analysis device—a transfer can be achieved—based upon the embodiment according to the invention of the transport carriage in the transport system—into the branch, or a continuation of the transport carriage on the main section can be achieved, without the requirement of a switch circuit in the transport track. Solely on account of a setting of different drive speeds of the driven wheels, which can in particular be arranged on an axle located at the rear in the direction of travel of the transport carriage, a direction of travel that points either to the left or to the right can be adopted here, so that, when a corresponding setting of the different drive speeds is carried out in a correspondingly spatially-adapted manner before the branch, the guide projection is transferred into the continued course of the longitudinal groove along a main travel path or else along the branch, and the transport carriage then moves correspondingly further along the main travel path or the main route or else curves into the branch. As already mentioned, switches or other adjusting mechanisms, which are susceptible to defects and failures due to their mechanically movable parts and frequently executed movements, can be omitted in the transport track itself along the travel paths.

However, if, as can certainly occur with known transport systems of the type mentioned at the outset, a corresponding component of the transport track fails and has to be replaced, this not infrequently leads to a failure in any case of larger sub-regions of the analysis laboratory, with a corresponding back-up of the specimens, a loss of throughput, and thus also of revenue. In the solution according to the invention, the technology required for specifying the direction of travel at branches with regard to mechanical adjustment and adjustability is transmitted exclusively to the transport carriage, which, in the event of a failure, can easily be removed from the transport system and, where applicable, replaced by a replacement carriage. The transport system itself does not fail, such that analysis laboratories can continue to operate normally.

A further aspect of the invention, which can in particular also be used independently of the particular embodiment of the transport carriage with four wheels and the guide projection and the transport track with longitudinal groove in a transport system according to the invention, is that the electrical energy store is formed by one or more capacitors. In known transport systems, the transport carriages are equipped with rechargeable batteries, or so-called accumulators. These certainly have the advantage that they store quite large amounts of electrical energy and thus can enable comparatively long travel times or operating times of the transport carriages. However, such accumulators are also comparatively heavy and bring additional weight into the transport carriages, which, on the one hand, increases the energy consumption and, on the other, is also accompanied by limitations for the dynamics of the transport carriages. In addition, such accumulators require comparatively large charging times, so that, in known transport systems, which operate with transport carriages having accumulators as energy stores, corresponding charging stations are to be provided in which a portion of the transport carriage fleet is always parked for charging the accumulators. These transport carriages cannot have taken part in the actual transport of the specimens, so that, when the transport system is outfitted, a corresponding additional number of transport carriages is to be used in order to take into account the proportion of the fleet that is sidelined due to the charging process.

In addition, accumulators can decrease in their charging capacity over a period in which they are used, so that they either have to be replaced after a certain operating time, or the entire transport carriage has to be replaced. This also results in a further maintenance effort and associated costs.

In contrast, electrical capacitors are advantageous as electrical energy stores. They can be constructed in a comparatively lightweight manner and allow an almost unlimited number of charging and discharging cycles compared to accumulators, thus having an increased service life. They can furthermore be charged with comparatively high currents and/or with the aid of short charging processes, which are due in particular to the ability to use comparatively high currents and which can be carried out in particular during the operation of the transport carriage. The disadvantage of capacitors—that they can only store a limited amount of charge and thus a limited amount of electrical energy—can be compensated for by shorter, cycled charging operations—in particular, during ongoing operation of the transport carriage. It is particularly advantageous if the capacitors used here are those having high capacitance—for example, so-called supercapacitors, or supercaps for short.

In particular, for—as indicated above—equipping the transport carriages with capacitors as energy stores, it can be advantageous that, in the transport track and along the travel paths, in portions, charging sections are provided for transmitting electrical charge to the transport carriage for charging the electrical energy store during a traversal over a charging section. Especially if capacitors which can store only small amounts of electrical energy compared to accumulators are used as an energy store for storing the electrical energy, such charging sections can ensure a continuous and clocked filling of the electrical energy during operation. The lengths and positions of the charging sections are to be coordinated while taking into consideration the overrun speeds in such a way that the electrical capacitors or other electrical energy stores are charged with electrical energy at least enough to reliably bridge a subsequent path section up to a renewed charging section arranged in the transport track, i.e., in such a way that a sufficient residual charge or residual quantity of electrical energy is still present in the electrical energy store when the transport carriage reaches the next charging sections for filling the electrical energy.

The electrical energy can be transmitted in different ways in the charging section, e.g., wirelessly, but also as a result of a mechanically-produced electrical contact. The latter possibility is advantageous, because it represents a simple and robust solution in which comparatively large amounts of electrical energy can be transmitted even with a short contact time. In addition, mechanical electrical transmission of energy does not involve the risk of crosstalk or interference of radio signals, which can be used, for example, for communication within the transport system. Correspondingly, according to an advantageous further development of the transport system according to the invention, conductor tracks—in particular, those made of copper—can run in the charging sections along the travel path, and the at least one transport carriage can have sliding-action or rolling contacts that can be brought into contact with these conductor tracks. Accordingly, when the transport carriage travels over the charging sections, an electrical connection is established by the contact between the conductor tracks and the sliding-action or rolling contacts, and electrical energy is transmitted to the transport carriage for storing in the electrical energy store—for example, the capacitor or capacitors as described above.

Advantageously, the aforementioned sliding-action or rolling contacts can be resiliently mounted on the transport carriage and can be pre-loaded into a position in which they are lifted off the transport track, and it can be provided that the sliding-action or rolling contacts be pulled against the conductor tracks against the spring tension in the region of the charging sections by magnetic force and brought into mechanical and thus also electrical contact. This magnetic force is in particular obtained by, at any rate, conductor tracks or sliding-action or rolling contacts being provided with a magnet in one of the elements, and a magnet or a magnetizable material being provided in the other of the elements. In particular in the region of the conductor tracks, a magnetizable material can be provided, e.g., in addition to a copper rail, and permanent magnets can be arranged on the spring-loaded sliding-action or rolling contacts. This embodiment prevents the sliding-action or rolling contacts from rubbing continuously on the transport track and thereby generating additional friction. A mechanical contact and a friction associated therewith are then provided only in those portions in which a charge transmission for filling the electrical energy store is actually carried out.

A further special aspect of the transport system according to the invention, which can also be implemented independently of the four-wheel design of the transport carriage and the provision of guide projection on transport carriages and longitudinal grooves in the transport track and also independently of the design of the energy store as a capacitor or capacitors, consists in the fact that, in order to form bidirectional communication with the transport carriage, first optical, and in particular infrared, communications interfaces can be integrated into the transport track and can be arranged in the region of the travel path, and in that second optical, and in particular infrared, communications interfaces are arranged on the transport carriage. The first and second optical communications interfaces are arranged such that they interact in a region with a first optical communications interface arranged therein when the transport carriage drives over said region. In this case, the first optical communications interfaces arranged in the transport track can in particular be elongated, e.g., with several identically-connected light-emitting or laser diodes, so that a communications link—in particular, of a bidirectional type—can be maintained through a time window when said track is driven over. Travel commands can be transmitted via such communications interfaces—in particular to the transport carriage, and more precisely the controller thereof—for example, in the region upstream of a branch in the transport track with respect to a direction of travel to be engaged along the main route or leading into the branch. Conversely, identification data, for example, which can clearly specify the transport carriage, which passes precisely the first communications point in the transport track, can be transmitted in the direction of the transport track, and from there, on to a central controller, for example. Such an optical communication is advantageous because it can be constructed in a spatially very limited manner and thus—in particular, when several such first communications interfaces are arranged in the transport track—cannot overlap, as is to be feared in radio communication in some cases. In addition, an optical communication, and in particular an infrared communication, can also be arranged in the transport track in a protected and covered manner by a cover that is permeable to the corresponding light wavelength, which makes it robust and impervious to, for example, abrasion particles, dust, moisture, or the like.

A further aspect of the transport system according to the invention, which can be implemented in combination with the special features described above, but also independently, consists in a distance sensor which can be provided that is arranged in the transport carriage and connected to the controller, and has a measuring range pointing forwards in the direction of travel of the transport carriage. In this case, the controller is then set up in such a way that, in the event of an obstacle detected by the distance sensor and lying below a predetermined threshold value, the travel speed of the transport carriage is reduced, and/or the travel speed of the transport carriage is to be adjusted in the event of a moving obstacle to maintain a constant minimum distance. By way of such an embodiment, for example, a column travel of several transport carriages with uniform speed can be realized automatically. It can also be prevented that the transport carriage run unbraked into a stationary obstacle and collide therewith.

A further special aspect of the invention, which in turn can also be implemented in a transport system according to the invention in a manner that is detached from the previous aspects described as special features, consists in that the transport carriage can have a pushbutton switch on a side pointing forwards during operation in the direction of travel, the actuation of which pushbutton switch interrupts an electrical main supply line between the electrical energy store and electrical loads arranged in the transport carriage. As a result of such an embodiment, when the transport carriage hits an obstacle—in particular, as a result of specifically driving into an obstacle, e.g., into one of the above transport carriages or a track bumper or the like—it is possible to reduce energy consumption in the transport carriage to a minimum—ideally to zero—by separating the electrical store from all electrical loads arranged in the transport carriage, i.e., a complete shutdown of the systems of the transport carriage.

Especially if the electrical energy store is such that only a limited amount of electrical energy is able to be absorbed, e.g., a capacitor or an arrangement of capacitors, it is thus possible, in the event of the transport carriage standing still, to prevent the electrical energy store from being emptied by maintenance of the electrical functions and continuation of the electrical energy consumption, so that, when the holding is terminated in the worst case, there is no more energy to further move the transport carriage, i.e., to shift it. Because a pushbutton switch is used here, it is preloaded into a switch-on position, so that, when the obstacle is cleared, the push-button switch moves back into the switched-on position, and thus the connection between the electrical energy store and the loads on the transport carriage is restored, so that the transport carriage can then again be operated in its entirety and, in particular, can move in a self-driving manner.

If the transport track—as proposed in the first aspect of the invention—is provided with longitudinal grooves running along the travel paths, the pushbutton switch can in particular have a downward-pointing projection provided for engagement in the longitudinal groove. By means of such, it can then, for example, abut against a corresponding structure in the longitudinal groove and trigger when a hold of the transport carriage is to be achieved. For this purpose, for example, a reduction in the travel speed can be applied to the transport carriage beforehand via a communications link, and more precisely its control, so that a drive up to such a stop does not take place at an excessive speed which could endanger the specimen located on the transport carriage.

In a further independent aspect of the invention, it can be provided that stoppers be arranged in the transport track of the transport system at provided holding positions, wherein the stoppers either can be moved upwards out of the plane of the transport track for projecting into the travel path and for hitting against the transport carriage or, if a longitudinal groove is provided, can be introduced into this longitudinal groove. As a result, transport carriages can be stopped at provided holding positions, e.g., in a waiting position before being moved into the region of an analysis device; provided that more than one transport carriage arrives there with a specimen, and an earlier specimen has not yet been completely analyzed, a corresponding transport carriage still blocks the holding position on the analysis device.

If the transport carriage has a guide projection for engagement in a longitudinal groove defining the travel path, a contact ring can be formed on the guide projection, which contact ring is mounted via a roller bearing and can contact lateral boundaries of the longitudinal groove. The roller bearing can, for example, be a ball bearing, but also a needle bearing or another type of roller bearing. By means of such an arrangement with a roller bearing, a reduction in the friction is again attained, which arises when the guide projection is guided along a wall of the longitudinal groove—in particular, at higher speeds. This also helps to save electrical energy, which is relevant in particular when the energy store is such that it is capable of storing comparatively small amounts of electrical energy.

For similar movement reasons, in each case a laterally-projecting rolling ring mounted via a roller bearing can be provided on the transport carriage in the region of lateral corners located at the rear during operation. By such means—particularly where lateral, wall-like guide structures along the travel path are arranged on account of curves with small radii for safety reasons—a guide contact can be produced between the transport carriage and this guide structure, without thereby incurring excessive losses due to friction—in particular, for intercepting lateral forces or centrifugal force, and in particular at higher speeds.

A magnet can also be arranged, e.g., in the guide projection, so that the transport carriage has such a magnet for engagement in a longitudinal groove defining the travel path. Such a magnet can serve, for example, for activating control elements, and/or any stoppers located at provided stopping positions when driving over a sensor that is sensitive to magnetic fields—in particular, a Hall sensor—in the travel path, and in particular underneath the longitudinal groove. The presence of the transport carriage in the region of a sensor can also be indicated and/or detected by means of such a magnet; in this respect, the magnet can be used to locate the transport carriage. In particular, such a magnet can be arranged within the fastening of any roller bearing provided—in particular, a ball bearing, in particular, in a guide pin of the roller bearing, in particular, the ball bearing, can be integrated therein and/or form it (them); the magnet can furthermore in particular terminate flush with the roller bearing—in particular, the ball bearing—on the underside.

The receptacle, which according to the invention is arranged on the transport carriage, can in particular be a receiving tube having a bottom. In particular, a specimen vessel in the form of a cylinder tube can be set in such a receiving tube. Advantageously, this receiving tube can have a longitudinal cutout in its circumferential side wall, which then makes it possible, in particular, to read a coding, e.g., a barcode, arranged on the specimen vessel through this longitudinal cutout using a laterally-arranged reading device.

A further aspect of the transport system according to the invention, which in turn also independently has an inventive character, is given by the suggestion to assign a holder, formed on the transport carriage, for a closure cap associated with the specimen to the receptacle, provided on the transport carriage, for the specimen to be transported. Typically, the specimens, and more precisely the specimen vessels, are transported opened so that specimen contents can readily be removed at the respective analysis stations. Because the specimens or specimen vessels are generally supplied to an archive at the end of the run through the medical analysis laboratory, in which archive they are to be stored closed, they must accordingly be closed again with a closure cap. Ideally, the original closure cap can be used for this purpose—especially, because, as explained above in the description instructions, there are different closure caps which can not only be different in color, but are also different with regard to their size and function—for example, because different providers of specimen vessels use different independent standards.

By means of the suggestion explained above, specimen vessels and associated closure caps can then be obtained during the passage through the medical analysis lab along the transport system according to the invention as associated pairs, so that the specimen at the end of its path can be safely and securely closed again with the associated closure cap. In addition, replacement plugs can then be saved upon which in previous specimen management have been frequently used in medical analysis laboratories, with the associated negative consequences with regard to resource consumption and environmental impact associated with disposal. The holder for the closure cap can—for example, if the receptacle for the specimen to be transported is designed as a receiving tube as described above—be integrally formed on the edge of the receiving tube as a type of projecting tray.

Another aspect of the transport system described here, which is based upon an independent invention, is that a downward-pointing optical scanning sensor can be arranged on the transport carriage, with which optical scanning sensor a movement direction and a movement speed of the transport carriage relative to the transport track can be detected. Such an optical scanning sensor can be correspondingly formed, for example, like the optical sensors known in optical computer mice, with which sensors movement directions and speeds of the mouse housing can also be detected. Arranging such a scanning sensor on the transport carriage makes it possible to detect its driving speed and also the direction of movement—in particular, also along curved paths, i.e., in curved driving sections—and to transmit corresponding movement data to the controller, which data can also be taken into account when setting the travel speeds of the transport carriage. In this way, for example, driving too fast can be prevented, and excessive speeds in cornering can be avoided, which could otherwise lead to a possible tilting, falling over, or overflow of the specimen.

A transport system according to the invention can furthermore have a transport track formed in at least two, horizontally-superposed planes, wherein ramp portions then are provided which connect the planes arranged one above the other, so that the transport carriage can be moved along the ramp portions between the planes, i.e., can travel from a lower plane to an upper plane, or vice versa. Such an arrangement allows a space-saving formation of the transport system, and in particular of the transport track, with regard to the required footprint. In order to be able to form such ramp portions with a certain pitch and nevertheless to attain a sufficient contact pressure of the transport carriage on the web surface, it can be provided that a magnetic coupling between the transport carriage and the travel path be attained in the region of the ramp portions along the travel path, by at least one magnet, or otherwise magnetizable material, being arranged along the travel path and on the transport carriage. If an embodiment having charging sections and sliding-action or rolling contacts that are movable against a spring force into an extended position by means of magnetic force is provided, these magnetic connections can be used in the region of the ramp portions for providing the holding of the transport carriage on the base. For this purpose, charging sections can then in particular be formed in the region of the ramp portions.

All described advantages of a transport system according to the invention for transporting specimens in a medical analysis laboratory equally apply to a corresponding transport system for transporting specimens in a chemical analysis lab, and are transferable to this extent.

### BRIEF DESCRIPTION OF THE DRAWINGS

Further features and advantages of the invention and the technical solutions and special features comprised in the transport system disclosed here result from the following explanations of possible embodiments with reference to the accompanying figures. In the drawings:

FIG. 1 shows schematically, as components of a possible embodiment of a transport system according to the invention, a transport carriage according to the invention arranged on a transport track according to the invention;

FIG. 2 shows a transport carriage according to the invention of a transport system according to the invention from FIG. 1 in an oblique view;

FIG. 3 shows the transport carriage from FIG. 2 without a cover and in a view from the rear; and

FIG. 4 is a view of the underside of the transport carriage from FIG. 1.

### DETAILED DESCRIPTION

In the figures, a possible embodiment variant of a transport system according to the invention is illustrated in which different aspects, also implementable independently of one another and inventive, are implemented. In this respect, the following description of this embodiment variant is to be understood in such a way that the various special features and aspects can also be implemented independently of one another, and thus in the context of the invention individual features or combinations of features also provide an inventive contribution, and can be implemented within the scope of a new and inventive embodiment of a transport system or even individual components thereof, such as the transport track or also the transport carriage.

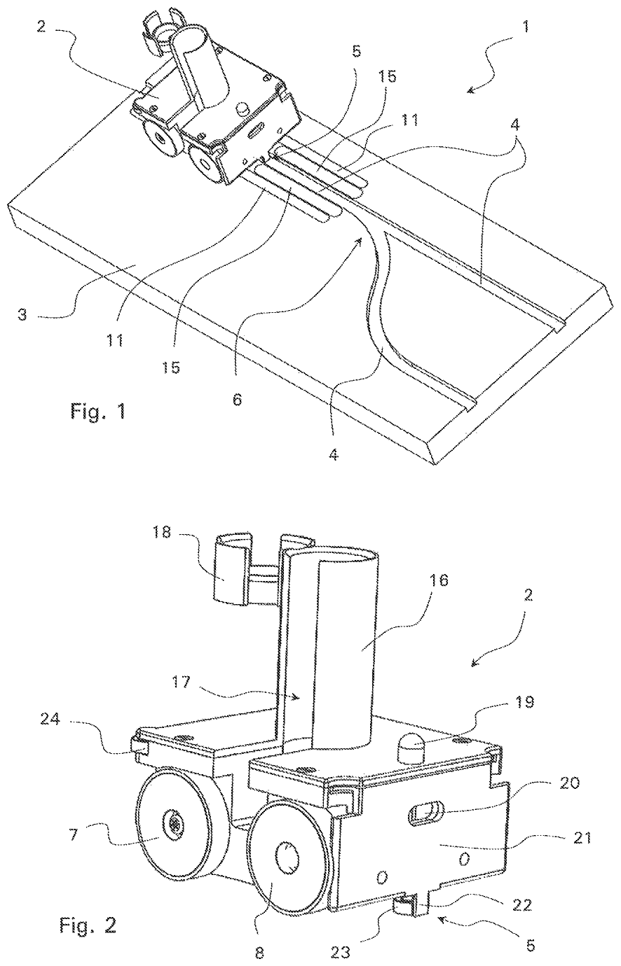

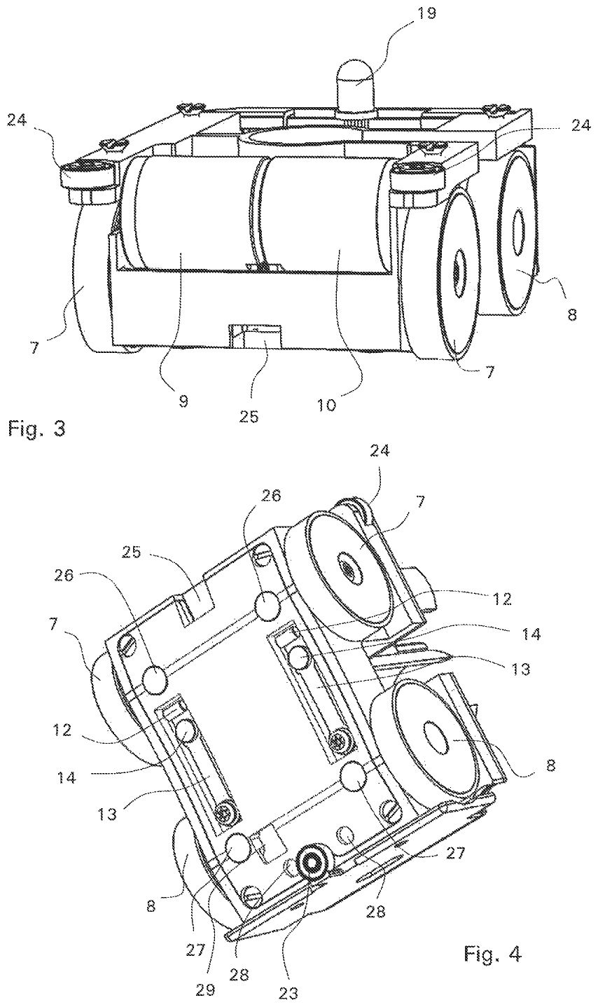

A transport system according to the invention, which can also be described as a conveyor system, is illustrated in FIG. 1 and is denoted there in general by the reference sign 1.

The transport or conveying system 1 is provided for use in a medical analysis laboratory and for transporting specimens therein. It represents the part of the laboratory apparatus that takes over specimens from a pre-sorting, e.g., an automatic sorting device, and conveys them to any desired destinations that can be specified for the system in the laboratory apparatus. These can, for example, be preparation devices, such as centrifuges, analytical devices, or also an archive. There is also the possibility of adding specimens to a sorter station for the purpose of further sorting.

The transport system 1 comprises at least one transport carriage—in practice, a plurality of individual, self-propelled transport carriages 2, which can also be referred to as specimen carriers and which are each provided for receiving exactly only one specimen and which serve to bring the specimen accommodated therein to a predetermined destination. The specimens are designed in the form of tube-shaped specimen vessels, containing the medical specimen actually to be analyzed, such as blood, urine, or the like, as are known in medical laboratory technology and have long been in use. At the respective destination, the specimens can be removed using a pick-and-place mechanism and be inserted in suitable racks or receptacles—for example, for further processing thereof.

A further component of the transport system 1 is a transport track 3 in addition to the at least one transport carriage 2. This transport track 3 forms a flat support on which the transport carriage(s) 2 move(s). The transport track 3 thus serves as a travel path for the transport carriage or transport carriage 2. Longitudinal grooves 4, which serve as guide grooves and into which a guide projection 5 of the transport carriage 2 enters, are introduced into the transport track for guiding the transport carriage 2 or the transport carriage 2 on predetermined travel paths. The longitudinal grooves 4 are divided into branches 6, so that separate travel paths are branched there as options which the corresponding transport carriage 2 can follow. The longitudinal grooves 4 divided into a branch 6 in turn run together at another point and are again combined (not shown here). Thus, in the transport track 3 of the transport system 1 according to the invention, the respective travel paths marked and predetermined by the longitudinal grooves 4 are always formed in a closed manner, equally as loops or else—not in the strictly geometric sense—circular paths. As a result, a transport carriage 2, which cannot yet be transferred into the destination section, e.g., on a branch 6, due to a jam there can continue in a circular course until the branch is clear for entry there at a next arrival. The transport track 2 can in particular also be designed on different planes lying one above the other, wherein ramp portions then are provided which connect the planes to one another and in which 4 travel paths are then predetermined by longitudinal grooves in the embodiment shown here.

In contrast to specimen carriers in other, similar systems, which are in part pushed in a sliding manner over the travel path, the transport carriage 2 in the transport system 1 according to the invention has four wheels 7, 8 in the embodiment shown. The wheels 7, 8 are arranged in two axles—one axle with the wheels 7 and one axle with the wheels 8. However, the wheels 7, 8 are each suspended in the axes individually, and not in a coupled manner. Furthermore, the wheels 7, 8 each have a support or a tire, i.e., via structures which, for one, contribute to improving the adhesion on the transport track 3, and which furthermore enable quiet operation. The wheels 7 thereby form the wheels located at the rear in the direction of travel of the transport carriage 2, i.e., the rear wheels. The wheels 8 can accordingly be seen as front wheels.

The transport carriage 2 is driven by two DC motors 9, 10, which each directly drive one of the wheels 7. In contrast, the wheels 8 are suspended in a free-running manner. The DC motors 9, 10 can thereby be regulated separately, so that the drive speeds or the rotational speeds of the two wheels 7 can be set independently of one another. For this purpose, the DC motors 9, 10 are connected to a controller (not shown in the figures) arranged on the transport carriage that controls and specifies the operation of the corresponding motor 9, 10. Both DC motors 9, 10 have a high dynamic and a high torque, which is highly advantageous for handling gradients—for example, when driving on the ramps connecting different planes of the transport track 2, and for driving at high speed. A further advantage is the separate controllability of the motors 9, 10. This enables the adaptation of the speeds between inner and outer wheel 7, e.g., in curves, and thus replaces a differential that is otherwise to be provided, i.e., saves upon a mechanical part that is susceptible to wear. Another important function of the drive selected here having two separate motors 9, 10 is the replacement of mechanical switch controls at branches 6 in the travel path with a simple-to-implement software control in the transport carriage 2. By means of this control, the selection of the direction of further travel to be checked in the branch 6 is effected by specifying different speeds of the driven wheels 7 instead of by a circuit of a switch in the driving section. If the transport carriage 2 is to pivot into the right-hand track at the branch 6, the DC motors 9, 10 are controlled in such a way that the left-hand rear wheel 7 correspondingly develops a higher torque in order to thrust the guide projection 6 to the right thereby and force it into the longitudinal groove 4 branching off on the right-hand side at the branch 6. Alternatively, braking of the right wheel can also lead to the same result. In this way, it is possible in particular to save upon a high expense for mechanical controls of switches in the transport track 3, with simultaneously significant improvement in the reliability of the system. In particular, this reduces the failure rate of the transport track 3.

The provision of four wheels 7, 8 on the transport carriage 2 has the advantage over the known solutions that the friction during propulsion along the transport track 3 is minimal, and ideally close to zero. The energy requirement for the propulsion thus drops considerably.

The energy storage for the operation of the DC motors 9, 10, the electronic control, and further consumers, e.g., the sensor system explained below, is realized in the embodiment shown by electrical capacitors (not shown in the figures). These capacitors can in particular be so-called supercaps, which have a high storage capacity.

Capacitors do indeed have a lower storage capacity compared to accumulators. However, they are lower in weight, and the number of charging cycles is almost unlimited, and in particular significantly higher compared to accumulators. This leads to a considerably long service life of these components and thus of the transport carriages 2 equipped therewith.

While accumulators have a high charging capacity, thus enabling a comparatively long driving operation of a transport carriage equipped with an accumulator, they also require long charging times in order to be recharged. This can take place only in a stationary manner in a charging station in which a transport carriage equipped with an accumulator has to be parked, and the battery has to be charged there. During the set-up time required for this purpose, the transport carriage is then not available for specimen transport, so that a number of carriages correspondingly increased by the number of transport carriages in the charging operation is to be provided in a transport system with battery-supplied transport carriages. In addition, the charging stations to be provided require space that then cannot be used for other purposes.

The power supply of the transport carriage 2 is provided by busbars 11, which are embedded in the transport track 3 in charging sections formed in portions, which sections in particular do not have to extend along the entire driving section.

In order to form a contact with the busbars 11, contacts 12 in the form of sliding-action or rolling contacts are arranged on the underside of the transport carriage 2, which contacts supply the capacitors with current via the busbars 11. The contacts 12 are arranged at free ends of spring tongues 13, which hold the contacts 12 in a rest position lifted and retracted from the transport track 3, but which can be deflected downwards due to their resilient property. This deflection is effected by magnets 14 arranged on the spring tongues 13, which magnets are attracted by an iron layer arranged underneath a copper layer in the busbar 11. As a result, the contact rollers of the contacts 12 are pressed onto the busbar 11, and the capacitors are charged in this way. The iron layer also terminates at the end of the busbar 11, so that the spring tongues 13 lift off again from the busbar 11 or the transport track 3. This contact and charging process, which normally lasts only fractions of seconds when driving over the busbar 11, is already sufficient to charge the capacitors with sufficient electrical energy for covering distances on the order of several meters, so that only a relatively small proportion of the sections must be equipped with busbars 11.

The above-described solution with capacitors as electrical energy stores in the transport carriage 2 and charging thereof when driving over busbars 11 via the contacts 12 offers the following advantages in particular:
The high capacitance capacitors that are used—in particular, in the form of so-called supercaps—can store high amounts of energy in a small space, which energy quantity suffices for operating the transport carriage 2 along a driving section of a few meters long.
The capacitors can be charged very quickly, viz., within fractions of seconds, so that the portions to be provided can be dimensioned with busbars 11 having a short extension.
A punctiform supply of energy is made possible, which makes a constant supply of energy or a stationary charging operation superfluous. In this way, the transport carriages 2 charge during operation, so that a smaller number of transport carriages 2 are required, and in particular a continuous 24/7 operation becomes possible.

In the transport track 3, regions transparent to infrared radiation and first optical communications interfaces 15 arranged therebelow are provided, by means of which a bidirectional communication between control elements in the transport track 3, and the transport carriage 2 is possible. Correspondingly, second optical communications interfaces 28, each in the form of an LED and a photodiode for bidirectional communication with the communications interfaces 15 in the transport track 3, are suitably located on the underside of the transport carriage and adapted to the arrangements of the first optical communications interfaces 15.

For example, the first optical communications interfaces 15 can be provided in a region upstream of a branch 6 in order to provide the transport carriage 2 there with a drive command, to follow the branch 6 in one of the two possible directions, for “turning,” e.g., the above-described control of the motors 9, 10 for a transfer into the branching strand of the longitudinal groove 4. The communications interfaces 15 are designed to be elongated in order to provide a sufficient transmission time for the communication even at higher travel speeds of the transport carriage 2. For example, a section of 50 mm would allow a communication time of 50 ms at a travel speed of the transport carriage of 1 m/s. This type of information transmission is also locally sharply limited, so that no crosstalk is to be feared, and it is very secure, and, especially, insensitive to external influences such as radio waves and other electromagnetic disturbances.

Because the transport track 3 does not contain any mechanical components and has a completely closed surface, the electronics contained therein are also well protected from dust and moisture.

The transport carriage 2 carries a receptacle 16 for an upright setting of tube-shaped specimen vessels. The receptacle 16 has a cutout 17 which terminates deep to the side and by means of which an automatic reading of identification codes over the entire length of the specimen tube is made possible.

A bracket 18 for a sealing plug of the specimen tube is provided on the side of the receptacle 16. With the aid of this bracket 18, specimen tubes can carry along their original plugs after removal of the closure plug—the so-called decapping—which plugs can be replaced, for example, after removal of an aliquot part from the specimen. This has numerous advantages over the previous procedure in which the plug is disposed of and later replaced by a standard plug, or in which the tube is closed by welding:
Greater economic efficiency by sparing the need for an additional plug;
Reduction in environmental impact from discarded plastic plugs;
Restoring the tube to the original state;
Secure closure of the tube by using the original plug;
Unproblematic decapping when the specimen tube is opened again;
Reduction, simplification, price reduction, and acceleration of decapper mechanics, and thereby simpler cascading of decappers to increase throughput.

In particular, a multi-color LED 19 can be provided on the transport carriage 2 and can provide information about the operating state of the transport carriage 2 during its operation with a color-coded indicator. For example, states such as “receiving charging current,” “communicated with communications-interface in the travel path,” or the like can be displayed with this LED 19.

Furthermore, in the embodiment shown, a proximity sensor 20 that is active towards the front end face is provided on the transport carriage 2. When approaching an obstacle, this ensures a reduction in the speed down to a low, controlled collision speed. The proximity sensor 20 also ensures that, in the case of transport carriages 2 running in succession, a constant spacing is maintained as a function of the speed of a transport carriage 2 traveling ahead.

Furthermore, in the embodiment shown, a pushbutton switch in the form of a shutoff plate 21 is provided on the front side of the transport carriage 2. When driving into an obstacle, this shutoff plate 21 ensures a complete shutdown of the electronics of the transport carriage 2 in order thereby to keep the electrical energy present in the capacitors stored until the transport carriage 2 is restarted. In order for this shut-off mechanism to function, the above-described driving into an obstacle at a controlled speed until shutoff is required. The shutoff plate 21 has a small appendage 22 which extends into the longitudinal groove 4. In processing points, the appendage of the transport carriage 2 moves against a stop slide and can be pushed into the longitudinal groove 4 and allows a particularly precise positioning of the transport carriage 2.

In the embodiment shown, a ball bearing 23 is fixed on the guide projection 5 in order to reduce friction in the longitudinal groove 4. This is particularly important in curves that are driven through at high speed. In addition, the radius increased by the ball bearing 23 contributes to a smoothing of unevenness in the longitudinal groove 4 and thus to quieter running. A lateral support can be provided in the transport track 3 in curves that are driven through at high speed or in curves having a narrow radius. In this case, ball bearings 24 provided at the rear end of the transport carriage and which rest against the support with low friction then contribute to further stabilization of the transport carriage 2, so that curves having narrow radii can also be driven through at a relatively high speed.

Furthermore, in the embodiment shown, the transport carriage 2 has a recess 25 at its rear end. This enables a stop slide to ramp up when two transport carriages 2 are following one another closely. In this respect, this recess allows a controlled separation of two successive transport carriages 2.

In addition to its own weight, the transport carriage 2 can be pulled onto the travel path by magnets 26 in the region of the iron supports below busbars 11. This helps to reinforce the adhesion of the drive wheels 7 on any gradients or, together with a further pair of additional magnets 27 in the region of the front wheels, to prevent tilting towards the rear or towards the front on uphill or downhill gradients—in particular, at higher speeds. With a corresponding design, overhead travel is also conceivable—for example, for emptying transport carriages 2.

In the embodiment shown, a special optical sensor 29 is arranged on the transport carriage 2 on the underside thereof, which sensor can be referred to as a “mouse sensor.” This is a sensor as used in optical computer mice, with which distance measurement, directional detection, and also a speed determination can be carried out. When entering a curve, this sensor not only detects the curvature of a path section, but also allows the calculation of the radius of curvature, so that an optimal regulation of the drive speeds of the driven wheels 7 of the transport carriage 2 is possible.

A particular advantage of the design according to the invention described and realized in the embodiment described above is to be highlighted here again: while on the one hand the transport track 3 is mechanically completely passive up to the processing points—i.e., the locations at which the content or the specimens are processed into the PTS, which serves for their functional reliability—critical functions are shifted to the transport carriage 2. This has the advantage that, in the event of possible malfunctions, an affected transport carriage 2 can easily be removed from the system and replaced as needed with another transport carriage 2 without the function of the entire system suffering thereby, because it is not necessary to work on the transport track 3, which can be further used by the transport carriages 2.

### LIST OF REFERENCE SIGNS

1 Transport system
2 Transport carriage
3 Transport track
4 Longitudinal groove
5 Guide projection
6 Branch
7 Wheel
8 Wheel
9 DC motor
10 DC motor
11 Busbar
12 Contact
13 Spring tongue
14 Magnet
15 First optical communications interface
16 Receptacle
17 Cutout
18 Bracket
19 Multi-colored LED
20 Proximity sensor
21 Shutoff plate
22 Appendage
23 Ball bearing
24 Ball bearing
25 Recess
26 Magnet
27 Magnet
28 Second optical communications interfaces
29 Sensor

1. A transport system for transporting specimens in an analysis laboratory, said transport system comprising:
a transport track which predefines travel paths;
at least one self-propelled transport carriage which is configured for moving along the travel paths on the transport track, wherein the transport carriage has:
a receptacle for a specimen to be transported;
wheels driven by an electric motor drive;
an electrical energy store for providing electrical power for the electric motor drive of the wheels; and
a controller for the electric motor drive;
wherein the transport carriage has four wheels which are placed in an arrangement of two axels aligned parallel to one another;
wherein the wheels of a first axle are driven and the wheels of a second axle are not driven;
wherein the wheels of the driven first axle are each connected to a dedicated electric motor drive and are each drivable by means of the said dedicated electric motor drive at a rotational speed which is individually predefined by the controller;
wherein longitudinal grooves are routed along the travel paths in the transport track;
wherein a guide projection is formed on the transport carriage and protrudes from an underside thereof; and
wherein the guide projection is configured for engagement in the longitudinal grooves.

2. The transport system according to claim 1, wherein the electrical energy store is formed by one or more capacitors.

3. The transport system according to claim 1, further comprising charging sections provided in portions in the transport track and along the travel paths, wherein the charging sections are configured for transmitting electrical charge to the transport carriage for charging the electrical energy store during a traversal over a charging section.

4. The transport system according to claim 3, further comprising conductor tracks running in the charging sections along the travel paths, and by sliding-action or rolling contacts on the transport carriage, wherein the sliding action or rolling contacts are brought into contact with the conductor tracks.

5. The transport system according to claim 4, wherein the sliding-action or rolling contacts are resiliently mounted and are preloaded into a position in which the sliding-action or rolling contacts are lifted from the transport track and wherein magnets or a magnetizable material are provided in the charging sections; wherein magnets or a magnetizable material are provided on the resiliently-mounted sliding-action or rolling contacts in such a way that, when the transport carriage travels over the charging section, the sliding-action or rolling contacts are magnetically pulled in the direction of the conductor tracks and contact the conductor tracks.

6. The transport system according to claim 1, wherein, in order to form bidirectional communication with the transport carriage, first optical communications interfaces are integrated into the transport track and are arranged in a region of the travel paths, and wherein second optical communications interfaces are arranged on the transport carriage.

7. The transport system according to claim 1, further comprising a distance sensor arranged in the transport carriage and connected to the controller, wherein the distance sensor has a measuring range pointing forwards in a direction of travel of the transport carriage, wherein the controller is configured to reduce a travel speed of the transport carriage when there is an obstacle detected by the distance sensor and lying below a predetermined threshold value, and/or wherein the controller adjusts the travel speed of the transport carriage in an event of a moving obstacle and thereby to adhere to a constantly maintained minimum distance.

8. The transport system according to claim 1, wherein the transport carriage has a pushbutton switch on a side pointing forwards during operation, wherein actuation of the pushbutton switch interrupts an electrical main supply line between the electrical energy store and electrical loads arranged in the transport carriage.

9. The transport system according to claim 8, wherein the push button pushbutton switch has a downward-pointing projection provided for engagement in the longitudinal groove.

10. The transport system according to claim 1, further comprising stoppers arranged in the transport track at provided holding positions, wherein the stoppers are formed either so as to be movable upwards out of the plane of the transport track for projecting into the travel paths and for hitting against the transport carriage, or so as to be introducible into the longitudinal groove.

11. The transport system according to claim 1, further comprising a contact ring for contacting lateral boundaries of the longitudinal grooves, wherein the contact ring is mounted on the guide projection via a roller bearing.

12. The transport system according to claim 1, wherein the transport carriage has a laterally-projecting rolling ring mounted via a roller bearing in a region of lateral corners located at a rear of the transport carriage when viewed in a direction of travel during operation.

13. The transport system according to claim 1, wherein the receptacle provided on the transport carriage is a receiving tube having a bottom for the specimen to be transported.

14. The transport system according to claim 13, wherein the receiving tube has a longitudinal cutout in its side wall.

15. The transport system according to claim 1, wherein the receptacle for the specimen to be transported is associated with a holder formed on the transport carriage for a closure cap belonging to the specimen.

16. The transport system according to claim 1, further comprising a downward-pointing optical scanning sensor arranged on the transport carriage wherein the optical scanning sensor is configured to detect a movement direction and a movement speed of the transport carriage relative to the transport track.

17. The transport system according to claim 1, wherein a transport track is formed in at least two planes arranged horizontally one above the other, and wherein ramp portions are provided for connecting the at least two planes.

18. The transport system according to claim 17, wherein magnets or magnetizable material is provided in a region of the ramp portions along the travel paths, wherein the magnets or the magnetizable material interacts with magnets provided on the transport carriage or with a magnetizable material for generating a magnetic holding force for holding the transport carriage on the transport track.

19. The transport system according to claim 1, further comprising a plurality of identically-formed transport carriages, wherein each transport carriage of the plurality of identically-formed transport carriages has a unique, individual, and electronically-readable identifier.
